(19) United States
(12) Patent Application Publication
(10) Pub. No.: US 2024/0154113 A1
(43) Pub. Date: May 9, 2024

(54) AMPERE-HOUR-SCALE SODIUM-ION POUCH CELL

(71) Applicant: Nankai University, Tianjin (CN)

(72) Inventors: Fujun LI, Tianjin (CN); Tong ZHANG, Tianjin (CN); Suning GAO, Tianjin (CN); Hengyi FANG, Tianjin (CN); Meng REN, Tianjin (CN); Jun CHEN, Tianjin (CN)

(21) Appl. No.: 18/498,113

(22) Filed: Oct. 31, 2023

(30) Foreign Application Priority Data
Nov. 7, 2022 (CN) 202211383081.9

(51) Int. Cl. H01M 4/525; H01M 4/04; H01M 4/505; H01M 4/583; H01M 10/054; H01M 50/105

(52) U.S. Cl. CPC H01M 4/525; H01M 4/0416; H01M 4/0435; H01M 4/0471; H01M 4/505; H01M 4/583; H01M 10/054; H01M 50/105

(57) ABSTRACT

A sodium-ion pouch cell belongs to the technical field of new energy materials and devices. The pouch cell and comprises a cathode piece, a diaphragm, a presodiated anode piece, an electrolyte, a tab and an aluminum plastic film package, and is obtained by sequentially laminating 1 to 30 cathode pieces and 2 to 31 presodiated anode pieces in a Z-shaped manner, adding the electrolyte and packaging, the sodium-ion pouch cell is characterized in that: the cathode piece contains an O3 layered oxide cathode material, a chemical formula is NaₐNi_{b}Zn_{c}Fe_{d}MnₑTi_{(1-b-c-d-e)}O₂, 0.8≤a≤1, 0.2<b≤0.5, 0<c≤0.1, 0<d≤0.2, 0.2<e≤0.5, the presodiated anode piece contains a hard carbon anode material, and a double-sided density of the cathode piece is 28 mg/cm² to 33 mg/cm²; and a double-sided density of the anode piece is 14 mg/cm² to 16 mg/cm², and a battery capacity is 0.1 Ah to 10 Ah.

### CROSS REFERENCE TO RELATED APPLICATIONS

This application claims foreign priority of Chinese Patent Application No. 202211383081.9, filed on Nov. 7, 2022 in the China National Intellectual Property Administration, the disclosures of all of which are hereby incorporated by reference.

### TECHNICAL FIELD

The present invention belongs to the technical field of new energy materials and devices, and particularly relates to an ampere-hour-scale sodium-ion pouch cell.

### BACKGROUND OF THE PRESENT INVENTION

Sodium resources are very abundant on the earth, with an element content of about 23,000 ppm (wherein a lithium content is only about 17 ppm), are distributed all over the world, and are not restricted geographically. Therefore, in terms of resources, a sodium-ion battery has greater advantages than a lithium-ion battery. The sodium-ion battery studied can avoid the resource problem in the development of new energy batteries caused by lithium shortage, can gradually replace a lead-acid battery with serious environmental pollution, and can also continue to use materials, battery production procedures and production equipment of existing lithium-ion batteries, thus being considered as one of revolutionary technologies in the field of large-scale energy storage, and the sodium-ion battery has a quite optimistic industrialization prospect, and important economic value and strategic significance.

In recent years, sodium-ion batteries with different technical routes have been widely studied. Meanwhile, with the rapid development of the field of large-scale energy storage, the demand for the sodium-ion battery with a low cost, a high capacity and a long cycle life is increasing. At present, the study on the sodium-ion battery is mainly focused on a small button battery in a laboratory stage, which cannot directly reflect real problems in a battery system, and there is a lack of patents in which the most common pouch cell is studied. Therefore, it is of great significance to develop and optimize an assembly process of the sodium-ion pouch cell for the commercial application.

CN114976211 A discloses a sodium-ion pouch cell, this patent is based on a sulfate cathode and a hard carbon anode, while the pouch cell only exhibit a capacity less than 100 mAh and poor cycle stability. The compacted densities of cathode and anode are relatively low, so that it is difficult to assemble a large-capacity pouch cell. Meanwhile, there is a lack of key technology of presodiation for HC anode and the capacity match between cathode and anode.

### SUMMARY OF PRESENT INVENTION

The present invention aims to overcome the problems in the prior art and to provide a sodium-ion pouch cell, in which an O3 layered oxide is used as a cathode material and commercial hard carbon is used as an anode material, which can make up for an irreversible loss of sodium in combination with a novel chemical presodiation process for hard carbon anode. Meanwhile, an assembly process of the sodium-ion pouch cell is also optimized, and a higher compacted density is used, which can realize assembly of a large-capacity pouch cell, and area densities and capacity ratios of cathode and anode are optimized, which can realize stable operation of sodium-ion pouch cells of different ampere-hour-scale capacities.

A technical solution for realizing the object of the present invention is as follows:

The present invention provides an ampere-hour-scale sodium-ion pouch cell, which comprises a cathode piece, a diaphragm, a presodiated anode piece, an electrolyte, a tab and an aluminum plastic film package, and is obtained by sequentially laminating 1 to 30 cathode pieces and 2 to 31 presodiated anode pieces in a Z-shaped manner, adding the electrolyte and packaging, wherein the cathode piece contains an O3 layered oxide cathode material, a chemical formula is NaₐNi_{b}Zn_{c}Fe_{d}MnₑTi_{(1-b-c-d-e)}O₂, 0.8≤a≤1, 0.2<b≤0.5, 0<c≤0.1, 0<d≤0.2, 0.2<e≤0.5, the presodiated anode piece contains a hard carbon anode material, a single-sided density of the cathode piece is 14 mg/cm² to 18 mg/cm², and a double-sided density of the cathode piece is 28 mg/cm² to 36 mg/cm²; and a single-sided density of the anode piece is 7 mg/cm² to 10 mg/cm², a double-sided density of the anode piece is 14 mg/cm² to 20 mg/cm², a die-cutting size of the cathode piece is 53.5 mm to 83 mm*83.5 mm to 163 mm, a die-cutting size of the anode piece is 55.5 mm to 85 mm*85.5 mm to 165 mm, and a cell capacity is 0.1 Ah to 10 Ah.

Further, a preparation method of the O3 layered oxide cathode material comprises: crushing and mixing sodium carbonate, nickel oxide, zinc oxide, ferric oxide, manganese dioxide and titanium dioxide according to a molar ratio of 1:0.3:0.1:0.1:0.3:0.2, and calcining the mixture at a calcination temperature of 800° C. to 1, 100° C. and a heating rate of 1° C./min to 5° C./min under air atmosphere, wherein the calcination lasts for 12 hours to 20 hours.

Further, a preparation method of the cathode piece comprises: mixing the O3 layered oxide cathode material, Super-p and PVDF according to a mass ratio of 93:3:4, dispersing the above three materials in an N-methylpyrrolidone solvent, coating the mixture on two faces of an aluminum foil, drying the mixture at 80° C. to 100° C. in vacuum for 10 hours to 15 hours, so as to obtain the cathode piece, rolling the cathode piece until the compacted density is 2.6 g/cm³ to 3.0 g/cm³, and die-cutting the cathode piece until the size is 53.5 mm to 83 mm*83.5 mm to 163 mm. Preferably, the die-cutting size of the cathode piece is one of 163 mm*83 mm and 83.5 mm*53.5 mm.

Further, a preparation method of the presodiated anode piece comprises: mixing the hard carbon anode material, Super-p, styrene-butadiene rubber and carboxymethyl cellulose according to a mass ratio of 93:3:2:2, dispersing the above four materials in deionized water, then coating the mixture on two faces of an aluminum foil, drying the mixture at 70° C. to 90° C. in vacuum for 10 hours to 15 hours, so as to obtain the anode piece, rolling the anode piece until the compacted density is 1.0 g/cm³ to 1.5 g/cm³, die-cutting the anode piece until the size is 55.5 mm to 85 mm*85.5 mm to 165 mm, soaking the anode piece in a sodium diphenyl ketone solution for 2 hours to 4 hours, then cleaning the anode piece with a tetrahydrofuran solution, and drying the anode piece at 70° C. to 90° C. in vacuum for 8 hours to 12 hours, so as to obtain the presodiated anode piece. Preferably, the die-cutting size of the anode piece is one of 165.5 mm*85.5 mm and 85.5 mm*55.5 mm.

Further, a solvent of the solution for presodiation is ethylene glycol dimethyl ether, a solute of the solution for presodiation is diphenyl ketone and sodium, and a concentration of the solute is 0.001 mol/L to 2 mol/L. A preparation method of the presodiation solution comprises: adding the diphenyl ketone into the ethylene glycol dimethyl ether first, and then adding a sodium metal to form a saturated solution of diphenyl ketone and sodium.

Further, a concentration of the electrolyte is 1 mol/L, a solute is sodium hexafluorophosphate, and a solvent is a mixed solution obtained by mixing methyl ethyl carbonate, ethylene carbonate and dimethyl carbonate in a volume ratio of 1:1:1.

The present invention has the advantages as follows.

1. According to the present invention, the excellent stability of the O3 layered oxide cathode material is utilized to realize the excellent long-cycle stability of the pouch cell. Meanwhile, a novel chemical presodiated hard carbon anode can make up for an irreversible loss of sodium in a first cycle of a cell, thus obtaining higher coulombic efficiency of the first cycle. Appropriate compacted density is used, which can realize assembly of a large-capacity battery, and can reduce the addition amount of the electrolyte at the same time, thus being beneficial for the long-cycle stability of the battery.

2. The present invention provides the sodium ion batteries with different ampere-hour-scale capacity and the preparation method thereof, and the assembly process is easy to operate, thus being beneficial for large-scale production; and the pouch cell is low in cost and long in cycle life, and can be widely applied to the fields of new energy automobiles, large-scale energy storage and the like.

### DESCRIPTION OF THE DRAWINGS

FIG. 1 shows charge-discharge curves of the first cycle of a pouch cell in Embodiment 1;

FIG. 2 is a capacity cycle comparison chart of the pouch cell in Embodiment 1;

FIG. 3 shows charge-discharge curves of the first cycle of a pouch cell in Embodiment 2;

FIG. 4 is a capacity cycle comparison chart of the pouch cell in Embodiment 2;

FIG. 5 shows charge-discharge curves of the first cycle of a pouch cell in Embodiment 3;

FIG. 6 is a capacity cycle comparison chart of the pouch cell in Embodiment 3;

FIG. 7 shows charge-discharge curves of the first cycle of a pouch cell in Embodiment 4; and

FIG. 8 is an image of real products of the pouch cells in Embodiments 1 to 4.

### DETAILED DESCRIPTION OF PREFERRED EMBODIMENTS

The present invention is completely described in detail hereinafter with reference to the drawings.

### Embodiment 1

This embodiment provided a hundred-milliampere-hour-scale sodium-ion pouch cell, in which a cathode material was an O3 layered oxide and an anode material was commercial hard carbon.

The cathode material was prepared: an active material, a conductive agent and a binder were mixed according to a mass ratio of 93:3:4, that was, 1,000 g of O3 layered oxide cathode material, 32 g of Super-p and 43 g of polyvinylidene fluoride were taken to control an addition amount of an N-methylpyrrolidone solvent, and the mixture was coated on two faces of an aluminum foil when a viscosity was 8,000 cps and dried at 90° C. in vacuum for 12 hours, wherein a mass of the active material per unit area was 29 mg/cm² to 32 mg/cm². A preparation method of the O3 layered oxide cathode material comprised: crushing and mixing sodium carbonate, nickel oxide, zinc oxide, ferric oxide, manganese dioxide and titanium dioxide according to a molar ratio of 1:0.3:0.1:0.1:0.3:0.2, and calcining the mixture at a calcination temperature of 900° C. and a heating rate of 5° C./min under air atmosphere, wherein the calcination lasted for 15 hours.

The anode material was prepared: an active material, a conductive agent, a binder 1 and a binder 2 were mixed according to a mass ratio of 93:3:2:2, that was, 600 g of the O3 layered oxide cathode material, 19.5 g of Super-p, 12.9 g of styrene butadiene rubber and 12.9 g of carboxymethyl cellulose were taken to control an addition amount of deionized water, and the mixture was coated on two faces of an aluminum foil when a viscosity was 4,500 cps and dried at 90° C. in vacuum for 12 hours, wherein a mass of the active material per unit area was 14 mg/cm² to 18 mg/cm².

Positive and anode pieces were rolled: a hard carbon anode piece was rolled with a roll gap of 130 microns to obtain an anode piece with a compacted density of 1.02 g/cm³ to 1.1 g/cm³, and a cathode piece was rolled with a roll gap of 110 microns to obtain a cathode piece with a compacted density of 2.6 g/cm³ to 2.8 g/cm³.

The electrode pieces were die-cut: the cathode piece was die-cut into a cathode piece with a width of 53.5 mm and a length of 83.5 mm, which had a tab with a length of 8 mm and a width of 6 mm; and the anode piece was die-cut into an anode piece with a width of 55.5 mm and a length of 85.5 mm, which had a tab with a length of 8 mm and a width of 6 mm.

Presodiation treatment was carried out on the anode: under protection of an inert atmosphere, the die-cut anode piece was put into 1 mol/L sodium diphenyl ketone glycol dimethyl ether solution, the anode piece was taken out 2 hours later, washed with tetrahydrofuran for three times, and dried at 80° C. in vacuum for 12 hours to obtain a presodiated anode piece.

The pouch cell was prepared: 4 cathode pieces, a celgard 2400 diaphragm and 5 presodiated anode pieces were sequentially laminated in a Z-shaped manner and fixed with a special adhesive tape, the positive and anode pieces were welded through 0.1 mm*8 mm*60 mm aluminum tabs, sealed with an aluminum-plastic film outside, and dried at 80° C. in vacuum for 8 hours to control a water content to be lower than 20 ppm, then 4 ml of 1 M NaPF₆/EC+EMC+DMC (1:1:1 in volume ratio) electrolyte was injected, vacuum inflation was carried out for three times in a static machine, vacuum packaging was carried out on a cell, and the cell was allowed to stand for 24 hours, so as to obtain the sodium-ion pouch cell.

The pouch cell was activated: the pouch cell was charged at a current of 0.02 C until 3.4 V was reached, the pouch cell was charged at 0.05 C until 3.8 V was reached and then put aside at room temperature for 24 hours, then the pouch cell was charged at 0.1 C until 4.0 V was reached, and then the pouch cell was discharged at a constant current of 0.2 C until a cutoff voltage of 1.8 V was reached, so as to complete the battery activation.

Secondary packaging and testing were carried out on the pouch cell: a gasbag of the formed pouch cell was cut off, and the secondary packaging was carried out in vacuum; and the cycle testing was carried out on the pouch cell at a rate of 0.1 C to 2 C, and cutoff voltages of charge and discharge were 1.8 V and 3.9 V.

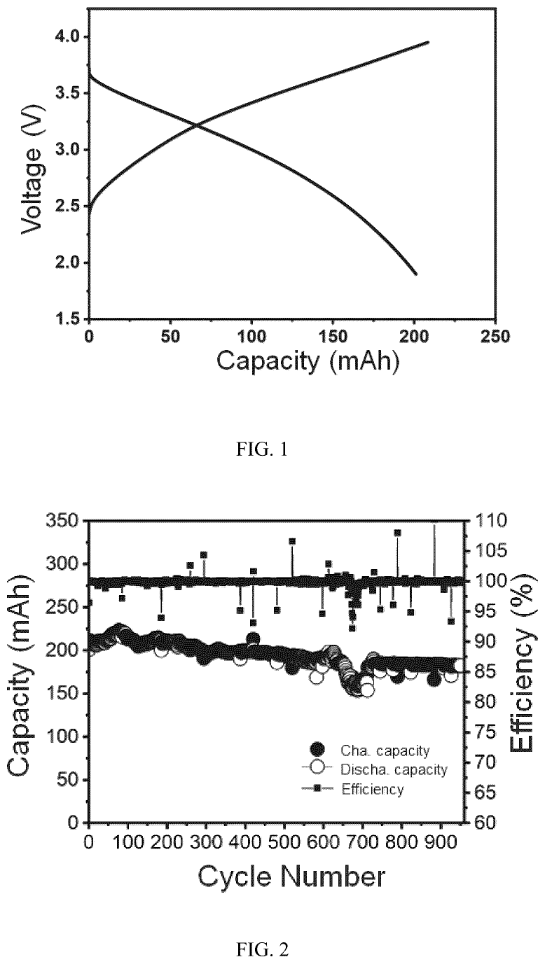

FIG. 8 is an image of a real product of the pouch cell assembled. A cycle performance of the pouch cell at a rate of 1 C is as shown in FIG. 1 and FIG. 2. A discharge capacity of a first cycle of the pouch cell is 205 mAh, and there is still a discharge capacity of 185 mAh after 900 cycles.

### Embodiment 2

This embodiment provided a one-milliampere-hour-scale sodium-ion pouch cell, in which a cathode material was an O3 layered oxide and an anode material was commercial hard carbon.

The cathode material was prepared: an active material, a conductive agent and a binder were mixed according to a mass ratio of 93:3:4, that was, 1,000 g of O3 layered oxide cathode material, 32 g of Super-p and 43 g of polyvinylidene fluoride were taken to control an addition amount of an N-methylpyrrolidone solvent, and the mixture was coated on two faces of an aluminum foil when a viscosity was 8,000 cps and dried at 90° C. in vacuum for 12 hours, wherein a mass of the active material per unit area was 29 mg/cm² to 32 mg/cm². A preparation method of the O3 layered oxide cathode material comprised: crushing and mixing sodium carbonate, nickel oxide, zinc oxide, ferric oxide, manganese dioxide and titanium dioxide according to a molar ratio of 1:0.3:0.1:0.1:0.3:0.2, and calcining the mixture at a calcination temperature of 900° C. and a heating rate of 5° C./min under air atmosphere, wherein the calcination lasted for 15 hours.

The anode material was prepared: an active material, a conductive agent, a binder 1 and a binder 2 were mixed according to a mass ratio of 93:3:2:2, that was, 600 g of the O3 layered oxide cathode material, 19.5 g of Super-p, 12.9 g of styrene butadiene rubber and 12.9 g of carboxymethyl cellulose were taken to control an addition amount of deionized water, and the mixture was coated on two faces of an aluminum foil when a viscosity was 4,500 cps and dried at 90° C. in vacuum for 12 hours, wherein a mass of the active material per unit area was 14 mg/cm² to 18 mg/cm².

Positive and anode pieces were rolled: a hard carbon anode piece was rolled with a roll gap of 130 microns to obtain an anode piece with a compacted density of 1.02 g/cm³ to 1.1 g/cm³, and a cathode piece was rolled with a roll gap of 110 microns to obtain a cathode piece with a compacted density of 2.6 g/cm³ to 2.8 g/cm³.

The electrode pieces were die-cut: the cathode piece was die-cut into a cathode piece with a width of 53.5 mm and a length of 83.5 mm, which had a tab with a length of 8 mm and a width of 6 mm; and the anode piece was die-cut into an anode piece with a width of 55.5 mm and a length of 85.5 mm, which had a tab with a length of 8 mm and a width of 6 mm.

Presodiation treatment was carried out on the anode: under protection of an inert atmosphere, the die-cut anode piece was put into 1 mol/L sodium diphenyl ketone glycol dimethyl ether solution, the anode piece was taken out 2 hours later, washed with tetrahydrofuran for three times, and dried at 80° C. in vacuum for 12 hours to obtain a presodiated anode piece.

The pouch cell was prepared: 11 cathode pieces, a celgard 2400 diaphragm and 12 presodiated anode pieces were sequentially laminated in a Z-shaped manner and fixed with a special adhesive tape, the positive and anode pieces were welded through 0.1 mm*8 mm*60 mm aluminum tabs, sealed with an aluminum-plastic film outside, and dried at 80° C. in vacuum for 8 hours to control a water content to be lower than 20 ppm, then 8 ml of 1 M NaPF₆/EC+EMC+DMC (1:1:1 in volume ratio) electrolyte was injected, vacuum inflation was carried out for three times in a static machine, vacuum packaging was carried out on a cell, and the cell was allowed to stand for 24 hours, so as to obtain the sodium-ion pouch cell.

The pouch cell was activated: the pouch cell was charged at a current of 0.02 C until 3.4 V was reached, the pouch cell was charged at 0.05 C until 3.8 V was reached and then put aside at room temperature for 24 hours, then the pouch cell was charged at 0.1 C until 4.0 V was reached, and then the pouch cell was discharged at a constant current of 0.2 C until a cutoff voltage of 1.8 V was reached, so as to complete the battery activation.

Secondary packaging and testing were carried out on the pouch cell: a gasbag of the formed pouch cell was cut off, and the secondary packaging was carried out in vacuum; and the cycle testing was carried out on the pouch cell at a rate of 0.1 C to 2 C, and cutoff voltages of charge and discharge were 1.8 V and 3.9 V.

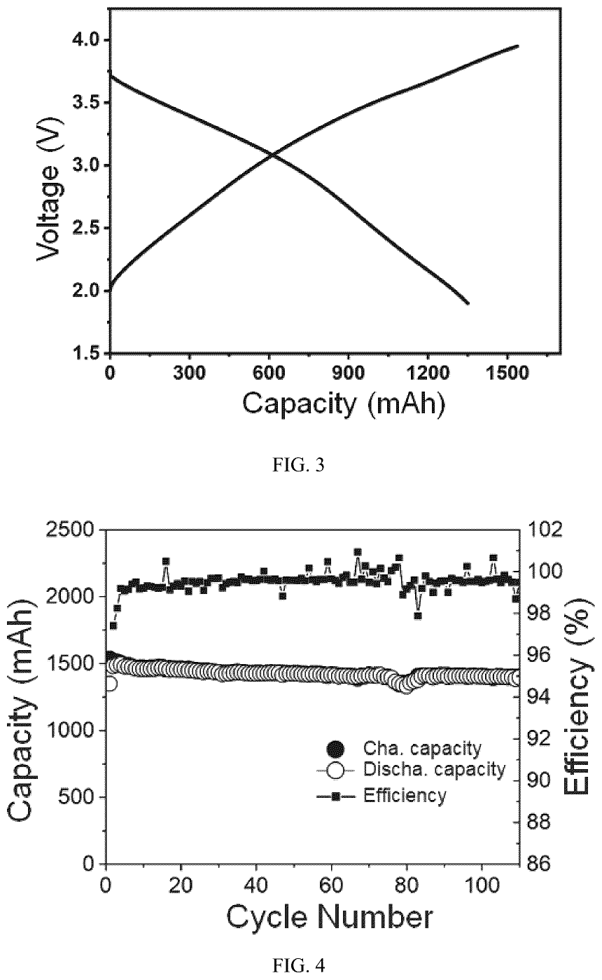

FIG. 8 is an image of a real product of the pouch cell assembled. A cycle performance of the pouch cell at a rate of 0.1 C is as shown in FIG. 3 and FIG. 4. A discharge capacity of a first cycle of the pouch cell is 1,470 mAh, and there is still a discharge capacity of 1,400 mAh after 110 cycles.

### Embodiment 3

This embodiment provided a five-milliampere-hour-scale sodium-ion pouch cell, in which a cathode material was an O3 layered oxide and an anode material was commercial hard carbon.

The cathode material was prepared: an active material, a conductive agent and a binder were mixed according to a mass ratio of 93:3:4, that was, 1,000 g of O3 layered oxide cathode material, 32 g of Super-p and 43 g of polyvinylidene fluoride were taken to control an addition amount of an N-methylpyrrolidone solvent, and the mixture was coated on two faces of an aluminum foil when a viscosity was 8,000 cps and dried at 90° C. in vacuum for 12 hours, wherein a mass of the active material per unit area was 29 mg/cm² to 32 mg/cm². A preparation method of the O3 layered oxide cathode material comprised: crushing and mixing sodium carbonate, nickel oxide, zinc oxide, ferric oxide, manganese dioxide and titanium dioxide according to a molar ratio of 1:0.3:0.1:0.1:0.3:0.2, and calcining the mixture at a calcination temperature of 900° C. and a heating rate of 5° C./min under air atmosphere, wherein the calcination lasted for 15 hours.

The anode material was prepared: an active material, a conductive agent, a binder 1 and a binder 2 were mixed according to a mass ratio of 93:3:2:2, that was, 600 g of the O3 layered oxide cathode material, 19.5 g of Super-p, 12.9 g of styrene butadiene rubber and 12.9 g of carboxymethyl cellulose were taken to control an addition amount of deionized water, and the mixture was coated on two faces of an aluminum foil when a viscosity was 4,500 cps and dried at 90° C. in vacuum for 12 hours, wherein a mass of the active material per unit area was 14 mg/cm² to 18 mg/cm².

Positive and anode pieces were rolled: a hard carbon anode piece was rolled with a roll gap of 130 microns to obtain an anode piece with a compacted density of 1.02 g/cm³ to 1.1 g/cm³, and a cathode piece was rolled with a roll gap of 110 microns to obtain a cathode piece with a compacted density of 2.6 g/cm³ to 2.8 g/cm³.

The electrode pieces were die-cut: the cathode piece was die-cut into a cathode piece with a width of 83 mm and a length of 163 mm, which had a tab with a length of 8 mm and a width of 6 mm; and the anode piece was die-cut into an anode piece with a width of 85.5 mm and a length of 165.5 mm, which had a tab with a length of 8 mm and a width of 6 mm.

Presodiation treatment was carried out on the anode: under protection of an inert atmosphere, the die-cut anode piece was put into 1 mol/L sodium diphenyl ketone glycol dimethyl ether solution, the anode piece was taken out 2 hours later, washed with tetrahydrofuran for three times, and dried at 80° C. in vacuum for 12 hours to obtain a presodiated anode piece.

The pouch cell was prepared: 14 cathode pieces, a celgard 2400 diaphragm and 15 presodiated anode pieces were sequentially laminated in a Z-shaped manner and fixed with a special adhesive tape, the positive and anode pieces were welded through 0.15 mm*12 mm*60 mm aluminum tabs, sealed with an aluminum-plastic film outside, and dried at 80° C. in vacuum for 8 hours to control a water content to be lower than 20 ppm, then 25 ml of 1 M NaPF₆/EC+EMC+DMC (1:1:1 in volume ratio) electrolyte was injected, vacuum inflation was carried out for three times in a static machine, vacuum packaging was carried out on a cell, and the cell was allowed to stand for 24 hours, so as to obtain the sodium-ion pouch cell.

The pouch cell was activated: the pouch cell was charged at a current of 0.02 C until 3.4 V was reached, the pouch cell was charged at 0.05 C until 3.8 V was reached and then put aside at room temperature for 24 hours, then the pouch cell was charged at 0.1 C until 4.0 V was reached, and then the pouch cell was discharged at a constant current of 0.2 C until a cutoff voltage of 1.8 V was reached, so as to complete the battery activation.

Secondary packaging and testing were carried out on the pouch cell: a gasbag of the formed pouch cell was cut off, and the secondary packaging was carried out in vacuum; and the cycle testing was carried out on the pouch cell at a rate of 0.1 C to 2 C, and cutoff voltages of charge and discharge were 1.8 V and 3.9 V.

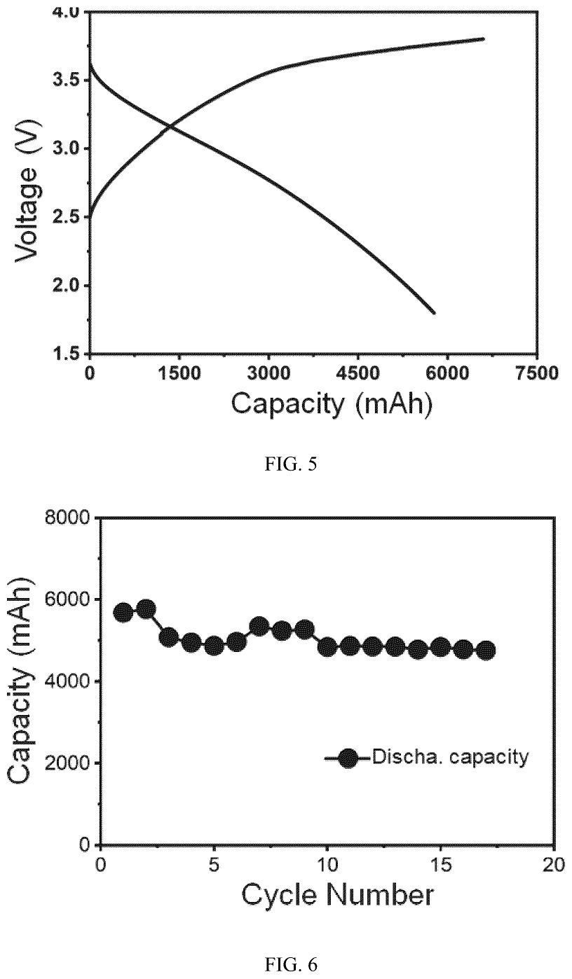

FIG. 8 is an image of a real product of the pouch cell assembled. A cycle performance of the pouch cell at a rate of 0.2 C is as shown in FIG. 5 and FIG. 6. A discharge capacity of a first cycle of the pouch cell is 5,770 mAh, and there is still a discharge capacity of 4,880 mAh after 900 cycles.

### Embodiment 4

This embodiment provided an eight-milliampere-hour-scale sodium-ion pouch cell, in which a cathode material was an O3 layered oxide and an anode material was commercial hard carbon.

The cathode material was prepared: an active material, a conductive agent and a binder were mixed according to a mass ratio of 93:3:4, that was, 1,000 g of O3 layered oxide cathode material, 32 g of Super-p and 43 g of polyvinylidene fluoride were taken to control an addition amount of an N-methylpyrrolidone solvent, and the mixture was coated on two faces of an aluminum foil when a viscosity was 8,000 cps and dried at 90° C. in vacuum for 12 hours, wherein a mass of the active material per unit area was 29 mg/cm² to 32 mg/cm². A preparation method of the O3 layered oxide cathode material comprised: crushing and mixing sodium carbonate, nickel oxide, zinc oxide, ferric oxide, manganese dioxide and titanium dioxide according to a molar ratio of 1:0.3:0.1:0.1:0.3:0.2, and calcining the mixture at a calcination temperature of 900° C. and a heating rate of 5° C./min under air atmosphere, wherein the calcination lasted for 15 hours.

The anode material was prepared: an active material, a conductive agent, a binder 1 and a binder 2 were mixed according to a mass ratio of 93:3:2:2, that was, 600 g of the O3 layered oxide cathode material, 19.5 g of Super-p, 12.9 g of styrene butadiene rubber and 12.9 g of carboxymethyl cellulose were taken to control an addition amount of deionized water, and the mixture was coated on two faces of an aluminum foil when a viscosity was 4,500 cps and dried at 90° C. in vacuum for 12 hours, wherein a mass of the active material per unit area was 14 mg/cm² to 18 mg/cm².

Positive and anode pieces were rolled: a hard carbon anode piece was rolled with a roll gap of 130 microns to obtain an anode piece with a compacted density of 1.02 g/cm³ to 1.1 g/cm³, and a cathode piece was rolled with a roll gap of 110 microns to obtain a cathode piece with a compacted density of 2.6 g/cm³ to 2.8 g/cm³.

The electrode pieces were die-cut: the cathode piece was die-cut into a cathode piece with a width of 83 mm and a length of 163 mm, which had a tab with a length of 8 mm and a width of 6 mm; and the anode piece was die-cut into an anode piece with a width of 85.5 mm and a length of 165.5 mm, which had a tab with a length of 8 mm and a width of 6 mm.

Presodiation treatment was carried out on the anode: under protection of an inert atmosphere, the die-cut anode piece was put into 1 mol/L sodium diphenyl ketone glycol dimethyl ether solution, the anode piece was taken out 2 hours later, washed with tetrahydrofuran for three times, and dried at 80° C. in vacuum for 12 hours to obtain a presodiated anode piece.

The pouch cell was prepared: 23 cathode pieces, a celgard 2400 diaphragm and 24 presodiated anode pieces were sequentially laminated in a Z-shaped manner and fixed with a special adhesive tape, the positive and anode pieces were welded through 0.15 mm*12 mm*60 mm aluminum tabs, sealed with an aluminum-plastic film outside, and dried at 80° C. in vacuum for 8 hours to control a water content to be lower than 20 ppm, then 45 ml of 1 M NaPF₆/EC+EMC+DMC (1:1:1 in volume ratio) electrolyte was injected, vacuum inflation was carried out for three times in a static machine, vacuum packaging was carried out on a cell, and the cell was allowed to stand for 24 hours, so as to obtain the sodium-ion pouch cell.

The pouch cell was activated: the pouch cell was charged at a current of 0.02 C until 3.4 V was reached, the pouch cell was charged at 0.05 C until 3.8 V was reached and then put aside at room temperature for 24 hours, then the pouch cell was charged at 0.1 C until 4.0 V was reached, and then the pouch cell was discharged at a constant current of 0.2 C until a cutoff voltage of 1.8 V was reached, so as to complete the battery activation.

Secondary packaging and testing were carried out on the pouch cell: a gasbag of the formed pouch cell was cut off, and the secondary packaging was carried out in vacuum; and the cycle testing was carried out on the pouch cell at a rate of 0.1 C to 2 C, and cutoff voltages of charge and discharge were 1.8 V and 3.9 V.

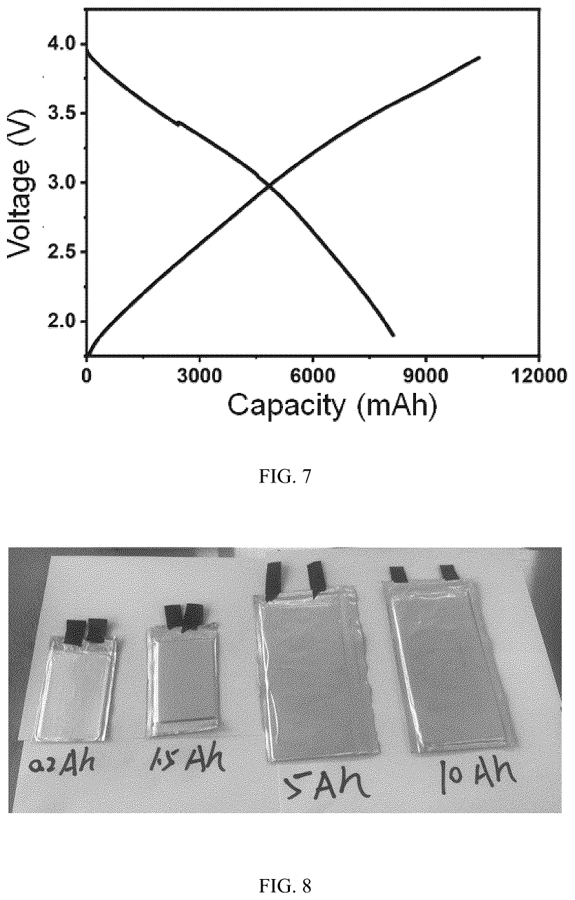

FIG. 8 is an image of a real product of the pouch cell assembled. An electrochemical performance of the pouch cell at a rate of 0.1 C is as shown in FIG. 7. A discharge capacity of a first cycle of the pouch cell is 8, 100 mAh.

The above are only the preferred embodiments of the present invention, and it should be pointed out that those of ordinary skills in the art may further make several modifications and improvements without departing from the concept of the present invention, and these modifications and improvements all fall within the scope of protection of the present invention.

We claim:

1. An ampere-hour-scale sodium-ion pouch cell, comprising a cathode piece, a diaphragm, a presodiated anode piece, an electrolyte, a tab and an aluminum plastic film package, and obtained by sequentially laminating 1 to 30 cathode pieces and 2 to 31 presodiated anode pieces in a Z-shaped manner, adding the electrolyte and packaging, wherein the cathode piece contains an O3 layered oxide cathode material, a chemical formula is NaₐNi_{b}Zn_{c}Fe_{d}MnₑTi_{(1-b-c-d-e)}O₂, 0.8≤a≤1, 0.2<b≤0.5, 0<c≤0.1, 0<d≤0.2, 0.2<e≤0.5, the presodiated anode piece contains a hard carbon anode material, and a double-sided density of the cathode piece is 28 mg/cm² to 33 mg/cm²; a double-sided density of the anode piece is 14 mg/cm² to 16 mg/cm², a compacted density of the cathode piece is 2.6 g/cm³ to 3.0 g/cm³, a die-cutting size is 53.5 mm to 83 mm*83.5 mm to 163 mm, a compacted density of the anode piece is 1.0 g/cm³ to 1.5 g/cm³, a die-cutting size is 55.5 mm to 85 mm*85.5 mm to 165 mm, and a battery capacity is 0.1 Ah to 10 Ah; and the presodiated anode piece is obtained by soaking an anode piece in a sodium diphenyl ketone solution and then cleaning and drying the anode piece in vacuum.

2. The ampere-hour-scale sodium-ion pouch cell according to claim 1, wherein a preparation method of the O3 layered oxide cathode material comprises: crushing and mixing sodium carbonate, nickel oxide, zinc oxide, ferric oxide, manganese dioxide and titanium dioxide according to a molar ratio of 1:0.3:0.1:0.1:0.3:0.2, and calcining the mixture at a calcination temperature of 800° C. to 1,100° C. and a heating rate of 1° C./min to 5° C./min under air atmosphere, wherein the calcination lasts for 12 hours to 20 hours.

3. The ampere-hour-scale sodium-ion pouch cell according to claim 2, wherein a preparation method of the cathode piece comprises: mixing the O3 layered oxide cathode material, Super-p and PVDF according to a mass ratio of 93:3:4, coating the mixture on two faces of an aluminum foil, drying the mixture at 80° C. to 100° C. in vacuum for 10 hours to 15 hours, so as to obtain the cathode piece, rolling the cathode piece until the compacted density is 2.6 g/cm³ to 3.0 g/cm³, and die-cutting the cathode piece until the size is 53.5 mm to 83 mm*83.5 mm to 163 mm.

4. The ampere-hour-scale sodium-ion pouch cell according to claim 3, wherein a preparation method of the presodiated anode piece comprises: mixing the hard carbon anode material, Super-p, styrene-butadiene rubber and carboxymethyl cellulose according to a mass ratio of 93:3:2:2, then coating the mixture on two faces of an aluminum foil, drying the mixture at 70° C. to 90° C. in vacuum for 10 hours to 15 hours, so as to obtain the anode piece, rolling the anode piece until the compacted density is 1.0 g/cm³ to 1.5 g/cm³, die-cutting the anode piece until the size is 55.5 mm to 85 mm*85.5 mm to 165 mm, soaking the anode piece in a sodium diphenyl ketone solution for 2 hours to 4 hours, then cleaning the anode piece with a tetrahydrofuran solution, and drying the anode piece at 70° C. to 90° C. in vacuum for 8 hours to 12 hours, so as to obtain the presodiated anode piece.

5. The ampere-hour-scale sodium-ion pouch cell according to claim 4, wherein a concentration of the sodium diphenyl ketone solution is 0.001 mol/L to 2 mol/L.

6. The ampere-hour-scale sodium-ion pouch cell according to claim 5, wherein a concentration of the electrolyte is 1 mol/L, a solute is sodium hexafluorophosphate, and a solvent is a mixed solution obtained by mixing methyl ethyl carbonate, ethylene carbonate and dimethyl carbonate in a volume ratio of 1 to 2:1 to 3:1 to 5.
